(19) United States
(12) Patent Application Publication
(10) Pub. No.: US 2017/0137217 A1
(43) Pub. Date: May 18, 2017

(54) Remote Control Transporter

(71) Applicant: Rizaldy E. Balanon, Oxnard, CA (US)

(72) Inventor: Rizaldy E. Balanon, Oxnard, CA (US)

(21) Appl. No.: 14/943,601

(22) Filed: Nov. 17, 2015

(51) Int. Cl. B65F 1/14

(52) U.S. Cl. CPC B65F 1/1468; B65F 1/1473

(57) ABSTRACT

A remote controlled trash transporter system is explained herein. The system includes a remote box with a remote transmitter, a trash carrier with aluminium wheels that allows smooth motion to and from the pick-up site, a carrier having a conveyor bar operatively communicated to the transport system, a remote transporter having a sliding gate for closing the opening which is fitted over the rail, a pair of rails, and a swivel plate placed over the carrier, which helps in trash bin rotation.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

This invention relates to the delivery of garbage from one location to another. More particularly, this invention relates to a remote controlled trash transporting system for household purpose or the like, and the transportation of trash from one place to another.

(2) Background of the Invention

Heretofore, refuse produced or discharged by residents of a building, such as a multiple dwelling house, an apartment, or the like, has been treated in such a way that the refuse is filled into plastic bags, plastic buckets, or the like by each resident in the building, and the bags or the buckets are brought by each resident from each room to an established refuse accumulation area or site on the lowest floor. For example, a resident brings one or more plastic bags that are filled with refuse, gets on an elevator box or goes down the stairs on foot to the established refuse accumulation area, and dumps them out on a predetermined refuse gathering day.

Furthermore, an installation called “trash transporting system” has also been employed, which is provided in a building for conveying refuse. The trash chute system is of a vertically extended hole structure in which a trash chute that is defined by surrounding side walls extends vertically through a building, and has openings in one of the side walls at respective floors through which residents can throw refuse.

When using the trash chute, residents put home refuse in a container, such as a plastic bag or plastic or metal bucket, bring the bag or the like container containing the refuse to the nearest opening, and throw away the refuse into the trash chute. The refuse falls down to the bottom of the chute, at the lowest floor, and is accumulated there. The accumulated refuse is taken out from the bottom portion of the chute at predetermined intervals, e.g., once a day or twice a weak.

Various other conventional systems are available that are related to trash chutes. For example: U.S. Pat. No. 5,000,641 to Shimizu Construction Co., Ltd., U.S. Pat. No. 5,762,083 to Skyscraper Cleaning Services Inc., U.S. Pat. No. 8,196,735 to Masami Sakita, U.S. Pat. No. 6,196,240 to Howard Liao, Hen Liao, Gun Je Liao, Han-Pin Liu, Chih Hsiung Kuo, and U.S. Pat. No. 4,285,624 to Herman Miller, Inc. k.

The conventional trash transporting methods described above have various problems. For example, carrying the refuse to the accumulation site on foot is a time-consuming job for residents, and bad smell is discharged from the refuse and hangs in the air when carrying the refuse from each home to the accumulation site. Also, in the former case, the comfortable or hygienic environment in the home is disrupted by the bad smell or similar discharge by the refuse which the residents are compelled to keep in the room in order to avoid dumping it in a public space such as the accumulation site on the day or days other than the specified gathering days. In this case, the refuse also adheres to the inner walls of the trash chute, and the adhering refuse gives off a bad smell in the air.

### SUMMARY OF THE INVENTION

Accordingly, it is an objective of the invention to provide a remote controlled trash transporter system for household purposes or the like that transports the trash from one place to another by means of using a remote controlled trash bin.

Therefore, the present invention provides a remote controlled trash transporter conveyor system for household purpose or the like, including:

(a) a remote box with a remote transmitter,

(b) a trash carrier with aluminium wheels that is used for storing and conveying trash,

(c) a carrier with a conveyor bar operatively communicating with the transport system,

(d) a remote transporter with a sliding gate for closing the opening that is fitted over the rail.

(e) a pair of rails, and

(f) a swivel plate.

Another objective of this invention is to provide a remote controlled trash transporter system for the transportation of garbage without contaminating the building.

A further objective of this invention is to provide a remote controlled trash transporter system for the transportation of garbage without manpower.

A further objective of the present invention is to provide a remote controlled trash transporter system that is simple and inexpensive to manufacture.

A further objective of the present invention is to provide a remote controlled trash transporter system that is simple to use.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

The invention will be better understood, and objectives other than those set forth above will become apparent, when consideration is given to the following detailed description thereof. Such description makes reference to the annexed drawings, wherein:

FIG. 1 is a structural schematic view showing the working of the remote controlled trash transporter system of this invention moving from one position (A) to another position (B)

FIG. 2 is a side view of the remote controlled trash transporter system, and

FIG. 3 is a schematic view of the remote transporter and swivel plate of this invention.

### DETAILED DESCRIPTION OF THE INVENTION

In the following detailed description, reference is made to the accompanying drawings, which form a part hereof, and in which is shown, by way of illustration, specific embodiments in which the invention may be practiced. These embodiments are described in sufficient detail to enable those skilled in the art to practice the invention, and it is to be understood that the embodiments may be combined, or that other embodiments may be utilized, and that structural, logical, and electrical changes may be made without departing from the spirit and scope of the present invention. The following detailed description is, therefore, not to be taken in a limiting sense, and the scope of the present invention is defined by the appended claims and their equivalents.

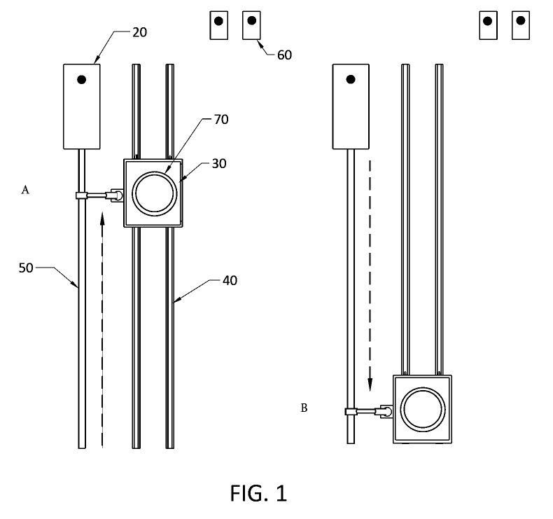

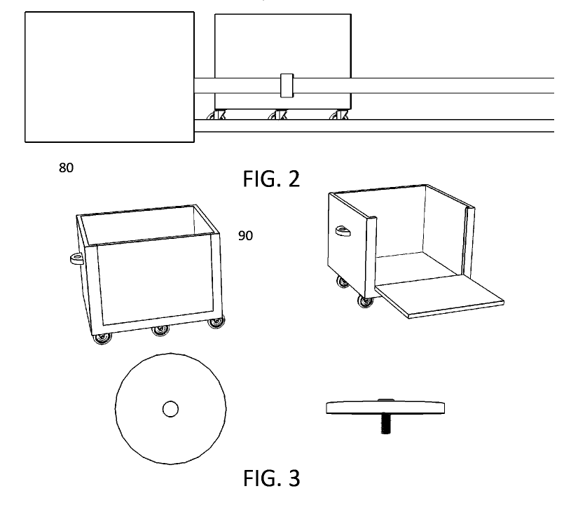

Referring now to FIG. 1, a remote controlled trash transporter system 10 moving from point A to point B is illustrated. The system FIG. 2 comprises a remote box 20 with a remote transmitter 60, a trash carrier 30 with Aluminium wheels 80, which allows smooth motion to and from the pick-up site, a carrier 20 that has a conveyor bar 50 operatively communicated to the transport system 10, a remote transporter 90 with a sliding gate for closing the opening that is fitted over the rail, a pair of rails 40, and a swivel plate 70 that is placed over the carrier, which helps in trash bin rotation.

FIG. 3 shows the remote transporter and swivel plate according to one embodiment of the present invention. The remote transporter includes a slidable gate, which is made of aluminium. The swivel plate is placed over the carrier and is able to turn or position the trash bin to a desired position.

This system is easy to operate. After the system is installed, the exterior garbage can is placed in the trash bin. Trash is placed on the carrier, as needed. On collection days, the user presses a remote switch on the remote control, which sends a signal to the remote box. The carrier is then motorized down the tracks to the collection site or curb.

Advantageously, from the description above, a number of embodiments of the remote controlled trash transporter system become evident, such as:

(a) The embodiment promotes safety by transporting heavy and awkwardly sized trash containers.

(b) This embodiment provides independence for individuals that are unable to drag their trash cans to the trash pick-up site due to handicap, old age, or other physical disabilities.

(c) The embodiment helps to prevent the spread of various kinds of germs and bacteria by reducing individual contact with trash cans.

(d) This embodiment beautifies the environment by automatically clearing the curb after sanitation pick-up.

(e) It saves the user money by clearing the curb, thereby preventing hefty fines imposed by the state government and local neighborhood housing authority.

(f) It is a pleasant convince to any user, reducing the time and energy usually needed to perform the essential task and chore of handling the garbage for garbage day.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages that may be provided by the present invention have been described above with regard to specific embodiments. These benefits and advantages, and any elements or limitations that may cause them to occur or to become more pronounced, are not to be construed as critical, required, or essential features of any or all of the embodiments.

While the present invention has been described with reference to particular embodiments, it should be understood that the embodiments are illustrative, and that the scope of the invention is not limited to these embodiments. Many variations, modifications, additions, and improvements to the embodiments described above are possible. It is contemplated that these variations, modifications, additions, and improvements fall within the scope of the invention.

I claim:

1. A remote controlled trash transporter system that comprises:
(a) a remote box with a remote transmitter,
(b) a trash carrier with aluminium wheels, which is used for storing and conveying trash,
(c) a carrier having a conveyor bar operatively communicated to the transport system,
(d) a remote transporter having a sliding gate for closing the opening which is fitted over the rail,
(e) a pair of rails, and
(f) a swivel plate.

2. The trash transporter system of claim 1, wherein said system promotes safety by transporting heavy and awkwardly sized trash containers.

3. The trash transporter system of claim 1, wherein said system provides independence for individuals that are unable to drag their trash cans to the trash pick-up site due to handicap, old age, or other physical disabilities.

4. The trash transporter system of claim 1, wherein said system beautifies the environment by automatically clearing the curb after sanitation pick-up.

5. The trash transporter system of claim 1, wherein said system, reducing the time and energy usually needed to perform the essential task and chore of handling the garbage for garbage day.
